(19) United States
(12) Patent Application Publication
(10) Pub. No.: US 2026/0318514 A1
(43) Pub. Date: Oct. 15, 2026

(54) TRAFFIC CHANNELIZING DEVICE WARNING-LIGHT MOUNT

(71) Applicant: Haylie Poche, Ponchatoula, LA (US)

(72) Inventor: Haylie Poche, Ponchatoula, LA (US)

(21) Appl. No.: 19/179,584

(22) Filed: Apr. 15, 2025

(51) Int. Cl. F21V 21/088; E01F 9/615; F16M 13/02; F21W 111/02

(52) U.S. Cl. CPC F21V 21/088; E01F 9/615; F16M 13/02; F21W 2111/02

(57) ABSTRACT

A traffic channelizing device warning-light mount system and method for mounting warning lights to traffic channelizing devices. A mount base unit has a front and back warning-light clamps at the top for mounting a warning light. Front and back channelizing-device clamping grids each descend from tracks within the mount base unit. Each clamping grid provides grid members and adjacent void areas providing locations for connection of the front and back clamping grids to each other through or around mounting structures of channelizing devices. The total combined area of the void areas is greater than the grid-member area, and widely distributed to allow visibility of retroreflective surfaces, colors, and patterns on the channelizing device. The front and back clamping grids are connected to each other by grid-tie fasteners passing through or around the mounting structure to maintain a clamping force on the channelizing device.

### BACKGROUND OF THE INVENTION

This invention provides a traffic channelizing device warning-light mount system and method for quickly, easily, securely, and safely mounting warning lights to traffic channelizing devices such as barricades, drums, cones, panels, and tubular markers.

Before performing construction, repair, or maintenance work on highways, roads, and streets it is necessary to set up channelizing devices such as barricades, drums, cones, panels, and tubular markers in order to divert traffic and to warn drivers or pedestrians of the upcoming diversion and then clearly mark the path of the diversion. If a driver fails to properly divert the driver and the vehicle could be injured or damaged and the construction workers and equipment could also be injured or damaged. In the US, the design and deployment of channelizing devices is subject to laws and regulations as published in the Manual on Uniform Traffic Control Devices for Streets and Highways, specifically in Section 6F.63, et seq., Channelizing Devices. Some US states and localities have additional or supplemental regulations. Other nations and jurisdictions have corresponding laws and regulations.

Types of channelizing devices include types 1, 2, and 3 barricades, indicating the number of horizontal rails, direction indicator barricades, vertical panels, cones, drums, and tubular markers. Drums are more crashworthy substitutes for 55-gallon steel drums which are no longer allowed. Drums are anchored in place with a large ring of heavy rubber, usually cut from an old tire, around the base. Tubular markers are more crashworthy forms of posts, and are also anchored with heavy rubber bases.

Different types of channelizing devices are required to be made of specific materials, are required to have specific sizes, dimensions, and configurations, to have retroreflective surfaces, and to show alternating areas of orange and white in bands or stripes of specified sizes and running either horizontally or diagonally according to the device type. Pertinent here, in use the retroreflective surfaces are not allowed to be covered or blocked from visibility and the visible pattern of alternating bands or stripes are not allowed to be covered, obscured, or altered but are to remain visible and identifiable.

In many circumstances warning lights are required to be used on the channelizing devices, with the design, specifications, placement, and use of such warning lights also being subject to the regulations. Some warning lights emit light only from the front, and others emit from the front and the back. In some circumstances the warning lights are required to flash on and off; in other circumstances the lights are prohibited from flashing and must burn steadily. The warning lights are available from various suppliers, and although the lights conform to the regulated specifications of design and dimensions, there can be variation among suppliers regarding some of the unregulated or less regulated aspects of design, dimensions, and performance.

Warning lights are mounted to barricades and panels at the top of a supporting vertical post, rather than to the rails or panels themselves. Warning lights are mounted to drums and tubular markers using mounting structures molded into the top surfaces and providing holes to accommodate mounting of a standard warning light. There is presently not a satisfactory standard way of mounting a standard warning light directly onto a barricade rail or a panel without blocking the retroreflective surface and obscuring the pattern of alternating diagonal stripes.

The channelizing devices, the mounted warning lights, any ballast, stabilizing, or anchoring structures, and everything attached to the channelizing devices must be crashworthy, avoiding risk of injury to vehicle drivers and passengers and to construction personnel if the channelizing device is struck by a vehicle. Pertinent here, the warning-lights should be designed, constructed, and mounted so as to avoid becoming dislodged and airborne in the event of a crash. Warning lights should be mounted securely enough to the channelizing devices to resist being dislodged by wind and weather, including the blowing or knocking over of the whole device.

Storing, handling, deploying, and retrieving the channelizing devices and the warning lights implicate different logistical concerns. Most types of channelizing device can be stacked or interleaved for storage and transportation, can be stored outdoors, and can be transported in open flat-bed trucks. Deployment of the channelizing devices can be done quickly by non-specialist workers, and without much risk of damaging the channelizing devices. The warning lights require more care in storing and handling because the lights require changing or recharging of batteries, and testing to ensure proper operation before deployment. The warning lights can be damaged by improper storage conditions and by rough treatment during transportation and deployment or improperly performed mounting. The warning lights are much more easily damaged by the same rough handling that the channelizing devices are able to withstand. Therefore, it is not a good practice to pre-mount the warning lights on the channelizing devices before transport and deployment, both because the lights are likely to be damaged, and because it is unlikely that the devices with pre-mounted lights will be placed at the correct locations and with the correct orientation, and more likely that the channelizing devices will be placed haphazardly as they come off the truck.

The warning-lights must be mounted in the proper specified position and location, which can vary among different types of channelizing device, different purposes for deploying the devices, and different layouts and configurations of devices, and different site-specific considerations. When it comes time to mount the warning lights it may be found that some barricades might have been placed incorrectly, such as with the stripes angled in the wrong direction, or that the wrong type of channelizing device was used, or that the devices were placed in the wrong location in relation to the road hazard. Also, the standard provided light-mounting structure on a device might be found to be broken, missing, or otherwise unusable. The standard method of mounting the warning light, using a special bolt installed at a specific location on the light base, requires the possession of a special tool to fit the special bolt. The special bolt requiring the special tool are intended to prevent later tampering with the light by pedestrians at the cost of making the mounting process more complex and cumbersome, which might be a reasonable trade-off for deployments on urban or suburban streets, but for deployments on busy highways where there is very little risk of pedestrian tampering the added complexity of the special bolt requiring the special tool are not necessary, and only serve to make the mounting process take longer and therefore leave the worker in a dangerous position on the side of the road longer. The special bolt requiring the special tool also make removal and retrieval of the warning lights more cumbersome and slower.

### SUMMARY OF THE INVENTION

This invention provides a traffic channelizing device warning-light mount system and method for quickly, easily, securely, and safely mounting warning lights to traffic channelizing devices such as barricades, drums, cones, panels, and tubular markers.

A mount base unit has a front warning-light clamp and a back warning-light clamp at the top for mounting a standard warning light. A front channelizing-device clamping grid and a back channelizing-device clamping grid each descend from tracks within the mount base unit. Each clamping grid provides grid members and adjacent void areas which provide several locations for connection of the front and back clamping grids to each other through or around the mounting structures of various channelizing devices. The total combined area of void areas is greater than the grid-member area, and the void areas are widely distributed, which provides sufficient void areas to allow visibility of retroreflective surfaces and allow identification of colors and patterns on the channelizing device. The front and back channelizing-device clamping grids are connected to each other by grid-tie fasteners passing through or around the mounting structure of the channelizing device, to maintain a clamping force on the channelizing device.

### BRIEF DESCRIPTION OF THE DRAWINGS

Reference will now be made to the drawings, wherein like parts are designated by like numerals, and wherein:

FIG. 1 is an isometric view of the traffic channelizing device warning-light mount of the invention with a warning light mounted;

FIG. 2 is a cutaway view of the traffic channelizing device warning-light mount of the invention with a warning light mounted;

FIG. 3 is an isometric view of an embodiment of the traffic channelizing device warning-light mount of the invention having a light connector loop, with a warning light mounted;

FIG. 4 is an isometric underside view of an embodiment of the traffic channelizing device warning-light mount of the invention having a light connector loop, with a warning light mounted;

FIG. 5 is a side view of the traffic channelizing device warning-light mount of the invention with a warning light mounted, having the front channelizing-device clamping grid and back channelizing-device clamping grid spaced apart for placement on a channelizing device in use;

FIG. 6 is a side view of the traffic channelizing device warning-light mount of the invention with a warning light mounted, having the front channelizing-device clamping grid and back channelizing-device clamping grid brought together and secured with grid-tie fasteners;

FIG. 7 is a front underside perspective view of the traffic channelizing device warning-light mount of the invention with the front channelizing-device clamping grid and back channelizing-device clamping grid tied together with grid-tie fasteners;

FIG. 8 is an isometric view of the traffic channelizing device warning-light mount of the invention;

FIG. 9 is an isometric view of an embodiment of the traffic channelizing device warning-light mount of the invention having a light connector loop;

FIG. 10 is an isometric view of the traffic channelizing device warning-light mount of the invention with the front channelizing-device clamping grid and back channelizing-device clamping grid tied together with grid-tie fasteners;

FIG. 11 is a perspective overview of the traffic channelizing device warning-light mount of the invention in use mounted on a vertical support of a type 3 barricade;

FIG. 12 is a perspective view of the traffic channelizing device warning-light mount of the invention in use mounted on a vertical support of a type 3 barricade;

FIG. 13 is a perspective view of an embodiment of the traffic channelizing device warning-light mount of the invention having a light connector loop, in use mounted on a drum;

FIG. 14 is a perspective view of the traffic channelizing device warning-light mount of the invention in use mounted on a tubular marker;

FIG. 15 is a perspective overview of the traffic channelizing device warning-light mount of the invention in use mounted on the rail of a type 1 barricade;

FIG. 16 is a perspective view of the traffic channelizing device warning-light mount of the invention in use mounted on the rail of a type 1 barricade, showing the preserved visibility of the rail stripes; and

FIG. 17 is a perspective overview of the traffic channelizing device warning-light mount of the invention mounted on a vertical support of a type 3 barricade before a warning-light is mounted in use.

### DETAILED DESCRIPTION OF THE INVENTION

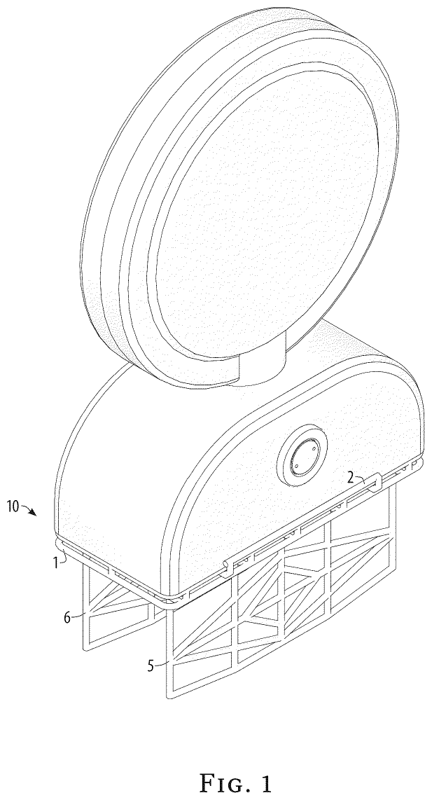

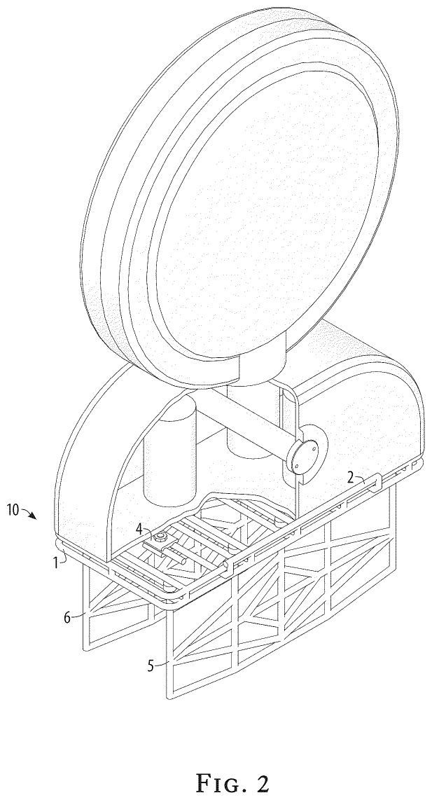

Referring to FIG. 1 and FIG. 2, the traffic channelizing device warning-light mount 10 system and method for quickly, easily, securely, and safely mounting warning lights to traffic channelizing-devices such as barricades, drums, cones, panels, and tubular markers provides a mount base unit 1 which holds underneath a front channelizing-device clamping grid 5 and a back channelizing-device clamping grid 6 in track slots which allow the clamping grids to be spaced apart from each other or be moved toward each other to clamp onto a variety of channelizing device structures. A standard warning light is securely and removably mounted on top of the mount base unit 1 and is held securely between a front warning-light clamp 2 and a back warning-light clamp 3 shown below. The clamping force between the front and back warning-light clamps is maintained by light-clamp fasteners 4 located within the mount base unit 1 which are easily accessible when the unit is not mounted to a traffic channelizing device but are not easily accessible when the unit is deployed and is mounted to a traffic channelizing device. The standard warning light has a special bolt with two holes corresponding to a special wrench. The special bolt is placed at a standard location on the base of the warning light. The special bolt is the standard existing means of attaching or mounting the standard warning light to the channelizing devices.

The front channelizing-device clamping grid 5 and the back channelizing-device clamping grid 6 have grid members of a solid material arranged as several intersecting rods or strips, and several void areas distributed around the clamping grid. As treated in detail below, the total combined void area is greater than the total combined grid-member area, and the distributed arrangement of grid members and void areas provides a very large number of points for connecting the front and back channelizing-device clamping grids 5, 6 together through holes and around structural parts of a variety of different types of channelizing devices.

The front and back orientation of the traffic channelizing device warning-light mount 10 is in relation to standard warning lights available from a number of sources and having standard dimensions and functions, with a small number of variations. The side of the warning-light base having the hole to receive the special bolt is considered to be the front of the warning light. If the warning light only emits light through one side, as opposed to emitting light through both sides, the light will be emitted from the front side, the same side as the hole for the special bolt. The front side of the traffic channelizing device warning-light mount 10 corresponds to the front side of the standard warning lights.

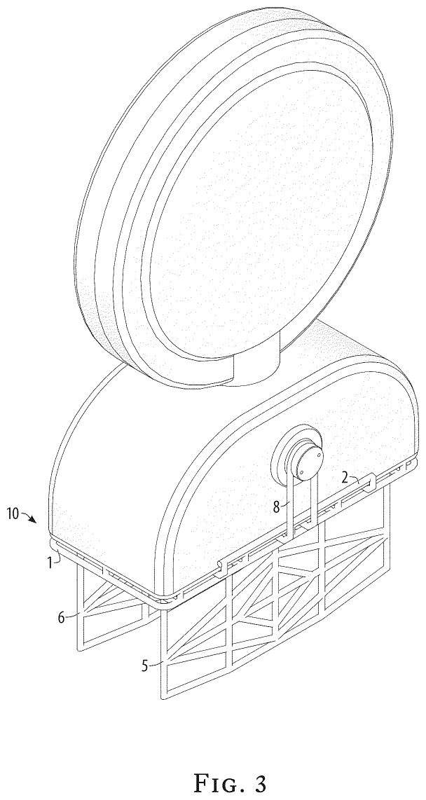

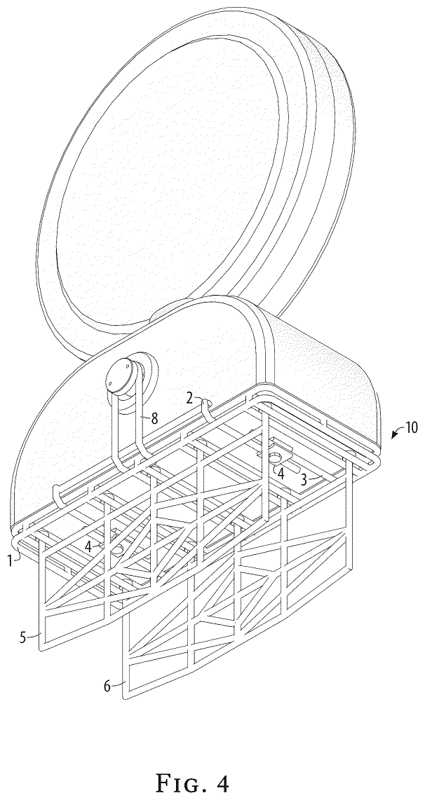

Referring to FIG. 3 and FIG. 4, an embodiment of the traffic channelizing device warning-light mount 10 additionally and optionally provides a light connector loop 8 additionally securing the mount base unit 1 to the warning light using the special bolt of the warning light.

The dimensions of the illustrated embodiments of the mount base unit 1 is 7 by 3.25 inches which matches the dimensions of standard warning lights. The depth of the illustrated mount base unit 1 is 0.375 inches. The mount base unit 1, the front and back warning-light clamps 2, 3, and the front and back channelizing-device clamping grids 5, 6 can be made of metal or of a suitably strong plastic or composite material. The use of strong materials helps allow the size of the grid members to be kept small in relation to the void areas. The material can be in the form of wires or rods bent and attached together, or in the form of plates with areas cut, drilled, or stamped out to create a substantial amount of void area to allow installation of grid-tie fasteners 20 in a variety of locations and to allow a substantial amount of colored, striped, and retroreflective surface to remain visible through the grids, as treated in detail below. Cutting of the plates can be done by die-cutting, laser-cutting, plasma-cutting, or a similar operation appropriate to the material used. If a material subject to deterioration is used, then proper painting, coating, plating, or other treatment should be used. Aluminum is one of several suitable materials from which the traffic channelizing device warning-light mount 10 can be made. Because crashworthiness and safety for drivers and pedestrians should not be compromised, sharp edges, points, protrusions, and other dangerous elements should be avoided. The illustrated embodiments are made from wire or rod having 0.125 inch diameter.

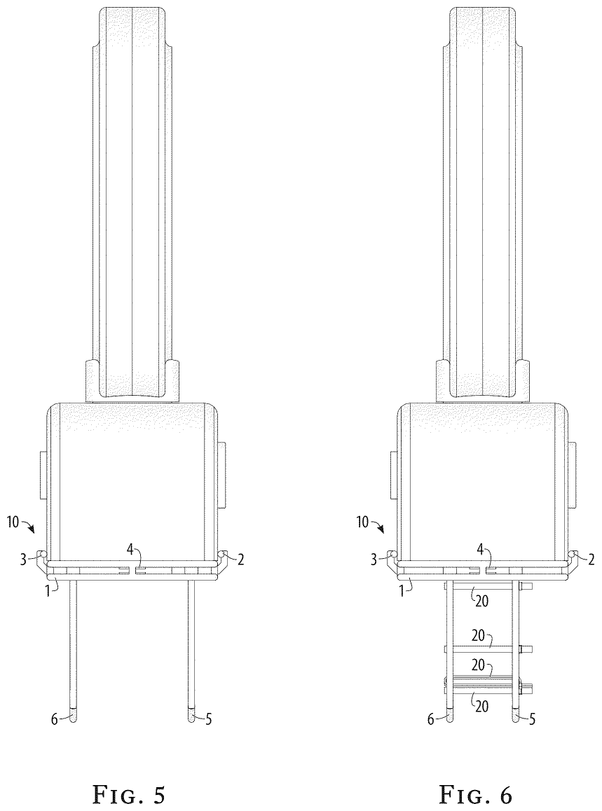

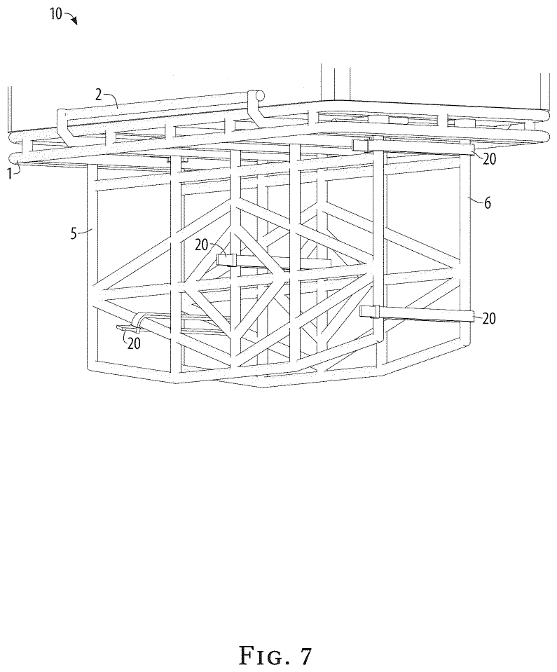

Referring to FIG. 5 and FIG. 6, the standard warning light is mounted to the mount base unit 1 and is held securely between the front warning-light clamp 2 and the back warning-light clamp 3 with the clamping force being maintained by the light-clamp fasteners 4. Before deployment and mounting on a traffic channelizing device the front channelizing-device clamping grid 5 and the back channelizing-device clamping grid 6 can be moved to be spaced apart from each other facilitating access to the light-clamp fasteners 4 and in preparation for placement on one of a variety of channelizing devices having a variety of sizes and configurations of structures and surfaces for installation. In use, the front channelizing-device clamping grid 5 and the back channelizing-device clamping grid 6 are brought together to clamp onto the channelizing device, and the front and back clamping grids are held together with grid-tie fasteners 20 which extend either above, around, or through a provided hole or void in the channelizing device. The use of standard plastic zip-ties as grid-tie fasteners 20 is illustrated. The grid-tie fasteners 20 could also be implemented as standard twist-ties or pieces of wire or cord, or as metal or plastic fasteners such as bolts and nuts. A lock or a locking device could also be used as an additional deterrent to tampering and theft. If locks or metal or heavy fasteners are used, care should be taken to avoid making the installation more dangerous in a crash or in pedestrian contact with the barrier. The use of grid-tie fasteners 20 such as zip-ties or twist-ties simplifies and speeds both the installation and the removal of warning lights from channelizing devices in the field. No special tool such as the special wrench for the special bolt is needed at all. The zip-ties or twist-ties can be installed by hand, without any tools, or using only standard pliers or an inexpensive zip-tie installation tool. Removal can be done using just a simple cutting tool. The same type of grid-tie fasteners 20 can be used for installation on any and all of the different types of channelizing devices which might be encountered, and therefore only one type of grid-tie fasteners 20 needs to be available in the field for any installation or series of installations. Although it is possible to choose a very strong material as a grid-tie fastener 20, it is not necessary that any single grid-tie fastener 20 be as strong as the standard special bolt because the invention provides for the use of up to several grid-tie fasteners 20 and because the traffic channelizing device warning-light mount 10 straddles and is mounted to both the front and back surfaces of the underlying structure instead of only being mounted to the front surface as in standard installations. Different types of grid-tie fasteners 20 can be used together as needed under specific circumstances. For example a warning light mounted on a barricade on a busy highway is less likely to be tampered with by a pedestrian than would be a warning light and barricade on an urban or suburban street, and plastic zip-ties might be sufficient on the highway while use on the street might require a mix of plastic zip-ties plus at least one sturdier and perhaps lockable type of grid-tie fastener 20.

The standard warning lights can be mounted to the traffic channelizing device warning-light mounts 10 well in advance of deployment and installation of the warning lights on channelizing device in the field. The mounting of the warning light to the traffic channelizing device warning-light mount 10 can be performed in the more controlled environment of a shop or a staging or marshaling area, and can be performed at the same time as maintenance work on the lights. Although recharging the lights using existing recharging units will likely require dismounting from the traffic channelizing device warning-light mount 10, new recharging units could be designed or modified to reach through the open configuration of the mount base unit 1 to allow for the recharging of some lights without removing the traffic channelizing device warning-light mount 10. Also, a new recharging unit could be designed to reach through the mount base unit 1 even when the traffic channelizing device warning-light mount 10 and light are mounted to a channelizing device. The warning lights with traffic channelizing device warning-light mounts 10 already mounted can be stored and can be transported to the field for installation on already deployed channelizing devices. Installing the warning lights after deployment and placement of the channelizing devices has the advantages of avoiding damage to the warning lights during possibly rough handling which might include transport in the back of a flatbed truck and being thrown out of that truck and being knocked over and dragged around, and also the advantage of avoiding finding that barricades with pre-installed lights have been placed incorrectly with the light at the wrong end or shining in the wrong direction. Any standard warning light which has been mounted to a traffic channelizing device warning-light mount 10 can be installed on any type of channeling device without any modifications or differences beyond possibly needing longer-than-usual grid-tie fasteners 20 in some cases.

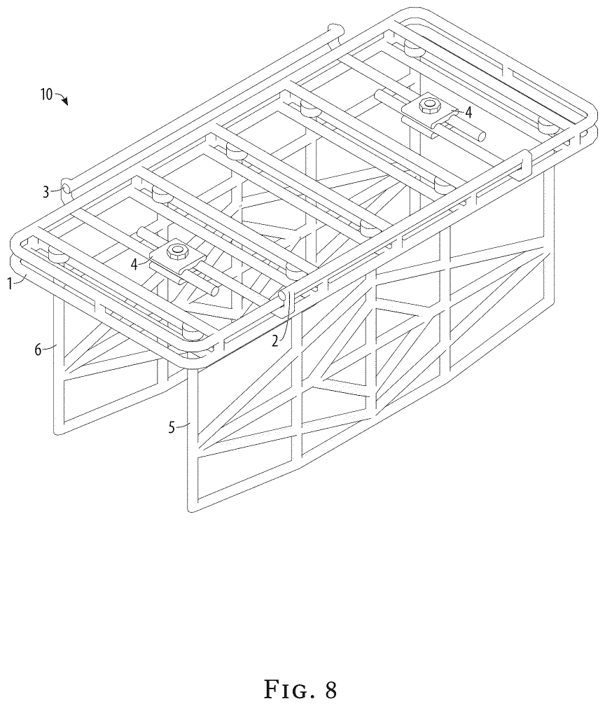

Referring to FIG. 7, the configuration of the front and back channelizing-device clamping grids 5, 6 as grids with several and substantial adjacent void areas allows for optimum placement of grid-tie fasteners 20 to accommodate the wide variety of channelizing devices upon which the traffic channelizing device warning-light mount 10 can be mounted. For example, one or more grid-tie fasteners 20 can be placed in or near the center of the grid, corresponding in many cases to a hole provided in the channelizing device for the purpose of mounting a warning light. With one or more grid-tie fasteners 20 installed through such a hole, the traffic channelizing device warning-light mount 10 and the warning light are fixed in place and cannot slip off of the channelizing device. Even if the clamping grids are not centered on a hole, the hole can be used and the grid-tie fasteners 20 can attach at other parts of the grid. Grid-tie fasteners 20 can also be installed near the mount base unit 1, which is appropriate when installing directly on a solid structure such as a rail itself, where the grid-tie fasteners 20 pass above the solid structure. Grid-tie fasteners 20 can be installed on or toward the edges of the clamping grids in order to apply supplemental clamping pressure or to be located adjacent to an unusual structure such as a larger loop at the top of a tubular marker. When needed, longer grid-tie fasteners 20 in the form of straps can be used to reach a longer distance under or around a structure. The minimum number of grid-tie fasteners 20 needed to be used for a specific installation will depend on many interrelated circumstances including specific type of fasteners used, specific type of channelizing device and mounting location, and many other factors. During most installations the placement of a first grid-tie fastener 20 will adequately hold the mounted light in position, and additional grid-tie fasteners 20 can be placed as needed for additional stability, either immediately or as a follow-up task, for instance after the correct mounting of the light is checked and verified. Because most types of grid-tie fasteners 20 chosen will be inexpensive and easy to install and remove, the use of extra grid-tie fasteners 20 should not significantly degrade the efficiency of the operation.

Referring to FIG. 8, the mount base unit 1 provides a front warning-light clamp 2 and a back warning-light clamp 3 which in use are moved toward the mount base unit 1 and therefore toward each other to securely clamp the base of the warning light the front and back warning-light clamps 2, 3 are held in a clamping position by the light-clamp fasteners 4. The front channelizing-device clamping grid 5 and the back channelizing-device clamping grid 6 are mounted to the mount base unit 1 in downward opening track slots which allow movement of the clamping grids away from and toward each other, which allows the traffic channelizing device warning-light mount 10 to be placed over and tightened against a variety of channelizing-device structures of various dimensions and configurations. At least two track slots are provided, although the provision of more track slots, such as the five track slots of the illustrated embodiments, is preferred because it provides additional strength and durability.

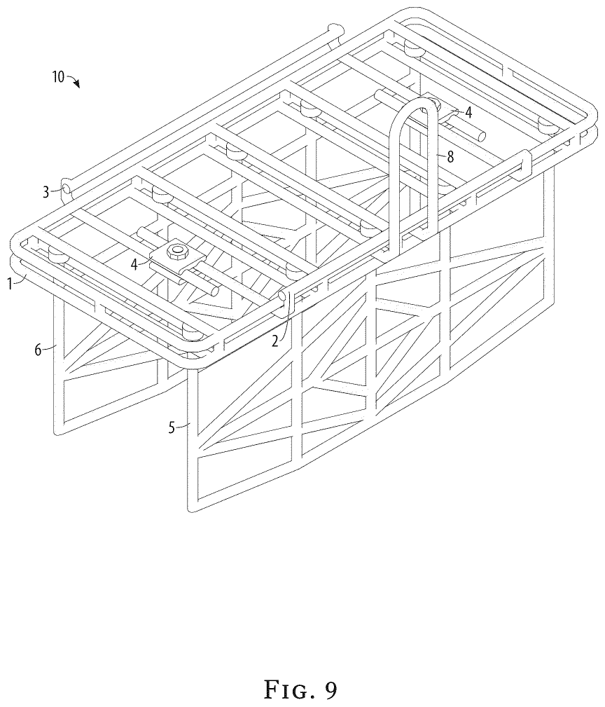

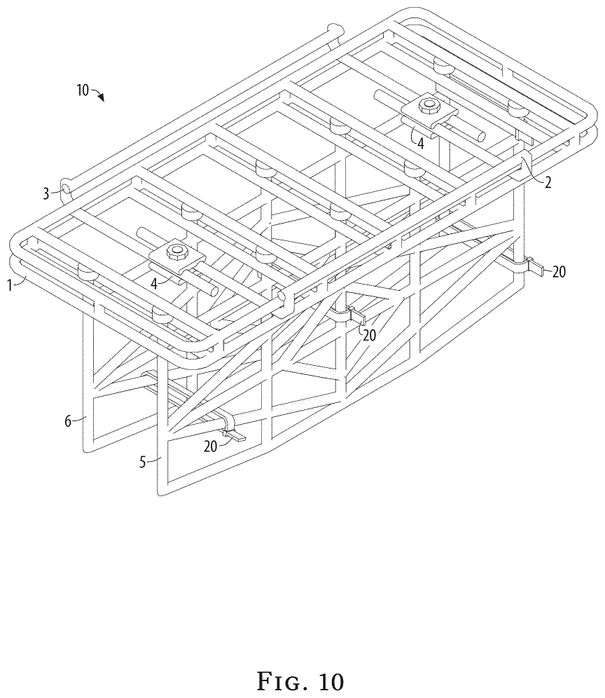

Referring to FIG. 9, in an embodiment of the traffic channelizing device warning-light mount 10 a light connector loop 8 is additionally and optionally provided for additionally securing the mount base unit 1 to the warning light using the special bolt of the warning light. Use of the light connector loop 8 does not interfere with use of the front warning-light clamp 2 and back warning-light clamp 3 held by the light-clamp fasteners 4.

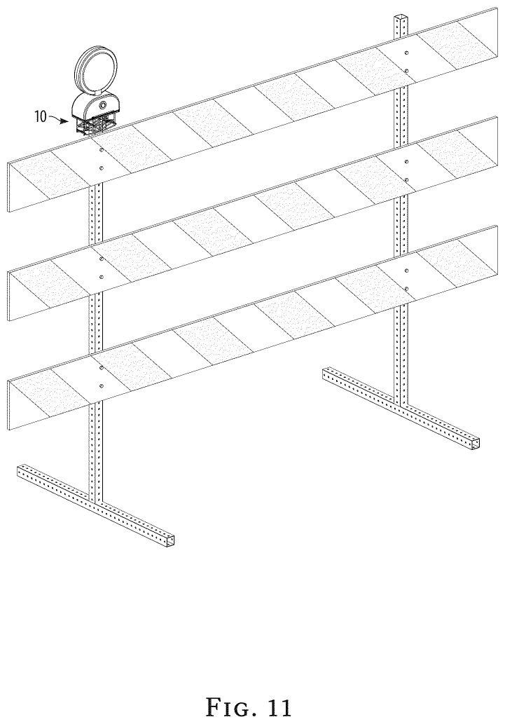

Referring to FIG. 10, in use during installation the front channelizing-device clamping grid 5 and the back channelizing-device clamping grid 6 can be brought together in tight contact with a variety of structures on a variety of channelizing devices, and can be held together using grid-tie fasteners 20 which can be placed variously above, around, and through holes or voids in the channelizing-device structure. During removal the grid-tie fasteners 20 can be removed and either re-used or discarded as appropriate, allowing the front and back channelizing-device clamping grids 5, 6 to move away from each other and from the channelizing-device structure, and the traffic channelizing device warning-light mount 10 can be removed for re-use. If the warning light is to be removed, the light-clamp fasteners 4 can be loosened, allowing the front and back warning-light clamps 2, 3 to move apart from each other and release the warning light from the mount base unit 1.

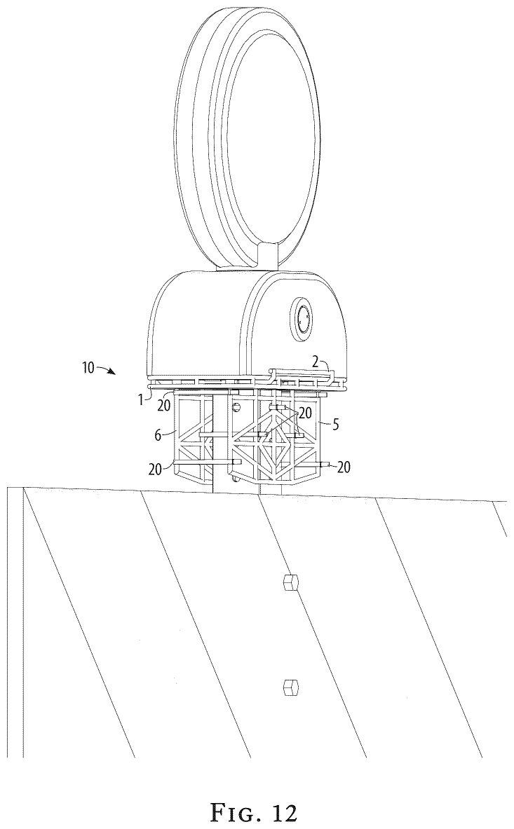

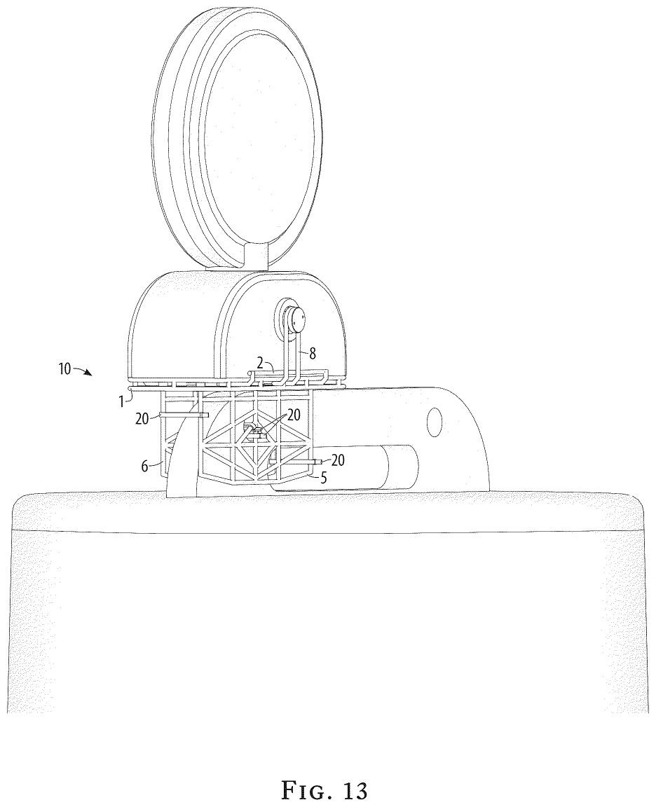

Referring to FIG. 11 and FIG. 12, the traffic channelizing device warning-light mount 10 can be mounted on the vertical support of a type 3 barricade, which is a common and standard location for mounting a warning light. The vertical support is a steel square tube having an array of holes. Using the common method of mounting, the special bolt of the warning light would be removed with a special wrench and the special bolt or a substitute special bolt would be used to mount the warning light through one of the holes of the vertical support extending above the top rail. If the special wrench is not readily available the installation is delayed. If the top portion of the vertical support has been crushed or damaged such that the holes are even slightly deformed or misaligned, the installation is delayed at least for the time it takes to turn the barricade around to place an undamaged vertical support in the proper position. One or more grid-tie fasteners 20 can be placed through one or more holes in the vertical support. It is not necessary that the holes be in proper alignment, or even that the holes be in alignment at all, because most types of grid-tie fasteners 20 will be flexible enough to enter and exit through holes not in alignment or at angles to each other. Even though passing through a hole in the underlying structure is usually desirable, it is not necessary. Grid-tie fasteners 20 can be wrapped around the vertical support and can still keep the mounted light centered. And additional grid-tie fasteners 20 placed away from and not touching the vertical support will reinforce the installation. If, in the field, it is found that the top of the vertical support is too damaged for mounting, the warning light can be mounted to the top rail instead, using the same grid-tie fasteners 20 on hand, without needing any additional equipment or supplies.

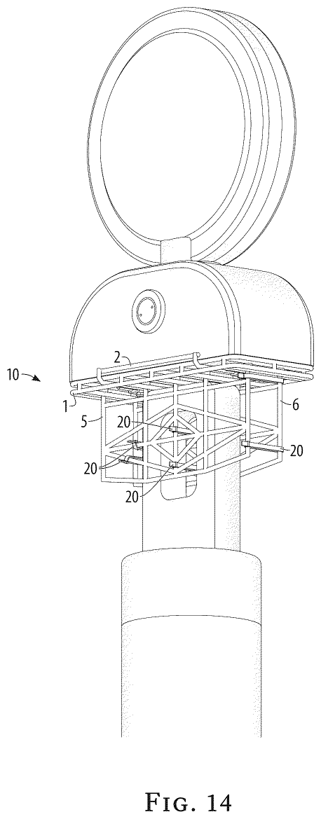

Referring to FIG. 13, the traffic channelizing device warning-light mount 10 can be mounted on a drum type of channelizing device, using one of the holes provided for mounting a warning light to one side or the other of the top of the drum, as required. Two grid-tie fasteners 20 in the form of zip-ties are passed through the single appropriate hole and are attached to the front and back channelizing-device clamping grids 5, 6 at or near the center, which fixes the warning light in position above the appropriate hole. Another grid-tie fastener 20 is passed through the carrying-handle cutout, providing additional clamping force and some additional protection against the light slipping off of the drum. Another grid-tie fastener 20 is passed through the area beyond the drum's handle structure, and provides additional clamping force. Also illustrated is the optional use of a light connector loop 8 secured by the special bolt of the warning light.

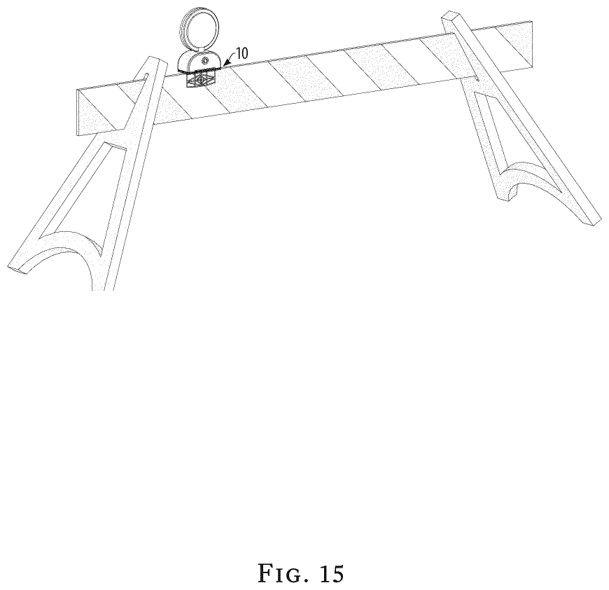

Referring to FIG. 14, the traffic channelizing device warning-light mount 10 can be mounted on a tubular marker type of channelizing device, using the top structure having a large hole or void space provided primarily to accommodate a chain or tape, but providing a satisfactory structure for mounting a warning light. Grid-tie fasteners 20 are placed through the central hole and outside the structure on either side, providing a secure mount.

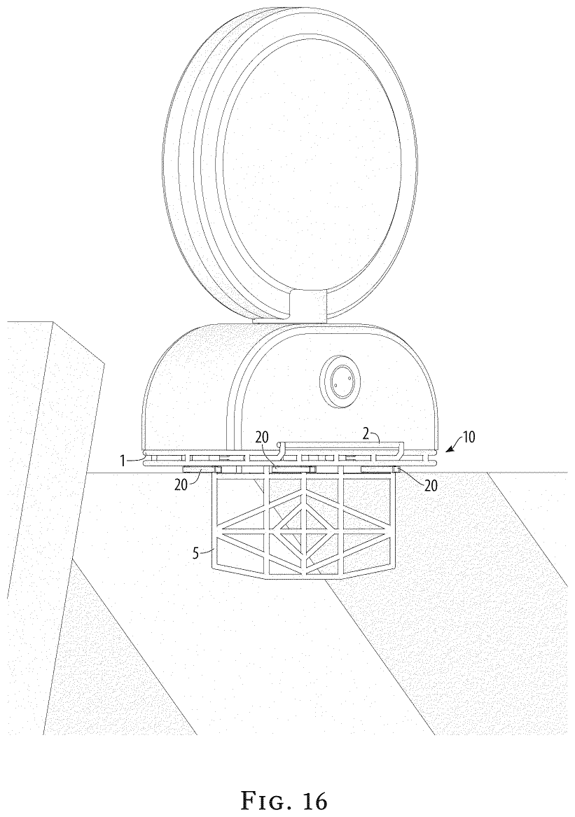

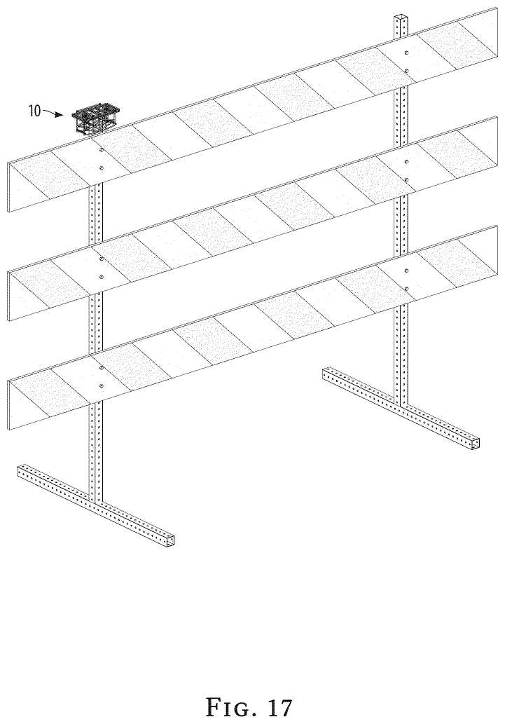

Referring to FIG. 15 and FIG. 16, the traffic channelizing device warning-light mount 10 can be mounted on the rail of a type 1 barricade, clamping directly to the rail. This type of mounting can also be used on the top rails of type 2 and type 3 barricades, on direction indicator barricades, and on vertical panel channelizing devices. Mounting directly to rails and panels without excessively blocking visibility of the stripe design and retroreflectivity is not adequately provided for presently in standard warning lights, and is a novel feature of the traffic channelizing device warning-light mount 10. The void areas of the front and back channelizing-device clamping grids 5, 6 are distributed around the grid adjacent to grid members and provide more void area than grid-member area, allowing most of the retroreflective material within the outline of the clamping grid to remain visible and fully retroreflective, and allowing the pattern of alternating colored stripes to remain visibly distinct and discernible. Provision of the void areas allowing continued visibility of the retroreflective surface and discernibility of the stripe pattern preserve the purpose and effectiveness of the visual properties of the rail required by the regulations. Specifically, in the illustrated embodiment the front channelizing-device clamping grid 5 is approximately 16 centimeters wide and extends downward on the 8-inch rail for approximately 6 centimeters underneath the grid-tie fasteners 20. The area covered and blocked by the grid members is approximately 35 square centimeters or 36%, and the area left open and visible is approximately 61 square centimeters or 64%. If further study of blocking and visibility indicates that more open space should be provided, the dimensions and design of the front and back channelizing-device clamping grids 5, 6 can be adjusted without compromising the clamping grids' function. The exact layout of the clamping grids as illustrated can be changed, keeping in mind that providing a concentration of grid members and void spaces around the central portion provides for taking advantage of mounting holes already existing on the channelizing devices.

Referring to FIG. 17, a method of using the traffic channelizing device warning-light mount 10, where the mounting of the standard warning light to the traffic channelizing device warning-light mount 10 occurring earlier and the mounting of the light already mounted to the traffic channelizing device warning-light mount 10 on the channelizing device occurring later, is disclosed in detail above. The method can also be practiced in an alternative order, with the mounting of the traffic channelizing device warning-light mount 10 only occurring earlier and the mounting of the light to the traffic channelizing device warning-light mount 10 already mounted to the channelizing device occurring later. Using the method in this alternative order will likely be more appropriate for certain channelizing devices in certain circumstances than for others. For example, drums and tubular markers are often stored and transported stacked within each other, and the early mounting of the traffic channelizing device warning-light mount 10 with or without a pre-mounted warning light might interfere with proper stacking and might lead to damaging or dislodging an already mounted traffic channelizing device warning-light mount 10, the warning light, or both. Also, the drums and the tubular markers are usually anchored in place using heavy rings of rubber placed over the top to settle at the base, and careless installation of the heavy rubber ring could also damage or dislodge an already mounted traffic channelizing device warning-light mount 10 or the warning light. Therefore, drums and tubular markers are most likely better deployed, placed, and anchored first, with the traffic channelizing device warning-light mount 10 having the warning light already mounted being mounted later. On the other hand, other types of channelizing devices such as the type 3 barricade illustrated are usually stored and transported in a horizontally arranged array with the horizontal base supports interleaved and the rails close to and parallel with each other. Such an arrangement would be unlikely to damage or dislodge a pre-installed traffic channelizing device warning-light mount 10 if there were any need for such pre-installation.

In the event of a warning-light needing to be removed and replaced while a channelizing device is still deployed, the warning light can be removed and replaced while the traffic channelizing device warning-light mount 10 is still mounted to the channelizing device by the use of a tool designed to reach and operate the light-clamp fasteners 4 within the mount base unit 1, which is placed and configured to discourage and prevent such tampering. Otherwise, the dismounting of the traffic channelizing device warning-light mount 10 from the channelizing device by cutting the grid-tie fasteners 20, and the remounting of the same or a different unit having a repaired or a replaced warning light mounted using new or reusable grid-tie fasteners 20, can be done quickly and easily using the methods described in detail above.

Many other changes and modifications can be made in the system and method of the present invention without departing from the spirit thereof. I therefore pray that my rights to the present invention be limited only by the scope of the appended claims.

1. A traffic channelizing device warning-light mount system comprising:
(i) a mount base unit having a top, bottom, front, and back orientation, having at least two track slots;
(ii) a front warning-light clamp and a back warning-light clamp on said mount base unit, adapted to clamp to a warning light on top of said mount base unit, and having light-clamp fasteners adapted to hold said front warning-light clamp and back warning-light clamp in a clamping relationship;
(iii) a front channelizing-device clamping grid and a back channelizing-device clamping grid, each having a plurality of grid members and having a plurality of adjacent void areas, where a total combined area of void areas is greater than a grid-member area, each mounted to track slots of said mount base unit and descending from the bottom of said mount base unit, together adapted to clamp to a channelizing device; and
(iv) at least one grid-tie fastener adapted to hold said front channelizing-device clamping grid and said back channelizing-device clamping grid together under a clamping force.

2. The traffic channelizing device warning-light mount system of claim 1, further comprising a light connector loop mounted to said base unit.

3. The traffic channelizing device warning-light mount system of claim 1, further comprising each said front channelizing-device clamping grid and back channelizing-device clamping grid having a total combined area of void areas greater than or equal to 60%.

4. The traffic channelizing device warning-light mount system of claim 1, where said front channelizing-device clamping grid and said back channelizing-device clamping grid are made of metal wire.

5. The traffic channelizing device warning-light mount system of claim 1, where said front channelizing-device clamping grid and said back channelizing-device clamping grid are made of metal rod.

6. The traffic channelizing device warning-light mount system of claim 1, where said front channelizing-device clamping grid and said back channelizing-device clamping grid are made of plastic material.

7. The traffic channelizing device warning-light mount system of claim 1, where said front channelizing-device clamping grid and said back channelizing-device clamping grid are made of composite material.

8. The traffic channelizing device warning-light mount system of claim 1, where said front channelizing-device clamping grid and said back channelizing-device clamping grid are made from a stamped plate of material.

9. The traffic channelizing device warning-light mount system of claim 1, where said front channelizing-device clamping grid and said back channelizing-device clamping grid are made from a drilled plate of material.

10. The traffic channelizing device warning-light mount system of claim 1, where said front channelizing-device clamping grid and said back channelizing-device clamping grid are made from a die-cut plate of material.

11. The traffic channelizing device warning-light mount system of claim 1, where said front channelizing-device clamping grid and said back channelizing-device clamping grid are made from a laser-cut plate of material.

12. The traffic channelizing device warning-light mount system of claim 1, where said front channelizing-device clamping grid and said back channelizing-device clamping grid are made from a plasma-cut plate of material.

13. The traffic channelizing device warning-light mount system of claim 1, where said mount base unit is made of metal wire.

14. The traffic channelizing device warning-light mount system of claim 1, where said mount base unit is made of metal rod.

15. The traffic channelizing device warning-light mount system of claim 1, where said mount base unit is made of plastic material.

16. The traffic channelizing device warning-light mount system of claim 1, where said mount base unit is made of composite material.

17. A traffic channelizing device warning-light mount method comprising:
(i) providing a traffic channelizing device warning-light mount system comprising:
(a) a mount base unit having a top, bottom, front, and back orientation, having at least two track slots;
(b) a front warning-light clamp and a back warning-light clamp on said mount base unit, adapted to clamp to a warning light on top of said mount base unit, and having light-clamp fasteners adapted to hold said front warning-light clamp and back warning-light clamp in a clamping relationship;
(c) a front channelizing-device clamping grid and a back channelizing-device clamping grid, each having a plurality of grid members and having a plurality of adjacent void areas, where a total combined area of void areas is greater than a grid-member area, each mounted to track slots of said mount base unit and descending from the bottom of said mount base unit, together adapted to clamp to a channelizing device; and
(d) at least one grid-tie fastener adapted to hold said front channelizing-device clamping grid and said back channelizing-device clamping grid together under a clamping force;
(ii) mounting a warning light on top of said traffic channelizing device warning-light mount system using said front warning-light clamp and said back warning-light clamp;
(iii) deploying a channelizing device along a street, road, or highway;
(iv) placing said traffic channelizing device warning-light mount system with a warning-light light mounted upon a mounting structure of the deployed channelizing device;
(v) clamping the mounting structure of the deployed channelizing device between said front channelizing-device clamping grid and said back channelizing-device clamping grid;
(vi) installing at least one said grid-tie fastener between said front channelizing-device clamping grid and said back channelizing-device clamping grid, passing through or around the mounting structure of the deployed channelizing device;
(vii) installing any additional said grid-tie fasteners needed to further secure the clamping force; and
(viii) activating the warning light mounted on the deployed channelizing device.

18. A traffic channelizing device warning-light mount method comprising:
(i) providing a traffic channelizing device warning-light mount system comprising:
(a) a mount base unit having a top, bottom, front, and back orientation, having at least two track slots;
(b) a front warning-light clamp and a back warning-light clamp on said mount base unit, adapted to clamp to a warning light on top of said mount base unit, and having light-clamp fasteners adapted to hold said front warning-light clamp and back warning-light clamp in a clamping relationship;
(c) a front channelizing-device clamping grid and a back channelizing-device clamping grid, each having a plurality of grid members and having a plurality of adjacent void areas, where a total combined area of void areas is greater than a grid-member area, each mounted to track slots of said mount base unit and descending from the bottom of said mount base unit, together adapted to clamp to a channelizing device; and
(d) at least one grid-tie fastener adapted to hold said front channelizing-device clamping grid and said back channelizing-device clamping grid together under a clamping force;
(ii) placing said traffic channelizing device warning-light mount system without a warning-light light mounted upon a mounting structure of the channelizing device;
(iii) clamping the mounting structure of the deployed channelizing device between said front channelizing-device clamping grid and said back channelizing-device clamping grid;
(iv) installing at least one said grid-tie fastener between said front channelizing-device clamping grid and said back channelizing-device clamping grid, passing through or around the mounting structure of the deployed channelizing device;
(v) installing any additional said grid-tie fasteners needed to further secure the clamping force;
(vi) deploying the channelizing device having said traffic channelizing device warning-light mount system mounted along a street, road, or highway;
(vii) mounting a warning light on top of said traffic channelizing device warning-light mount system mounted to the channelizing device; and
(viii) activating the warning light mounted on the deployed channelizing device.
